(19) United States
(12) Patent Application Publication
(10) Pub. No.: US 2007/0221419 A1
(43) Pub. Date: Sep. 27, 2007

(54) DETACHABLE DRIVE UNIT FOR MOBILE CARRIAGE

(76) Inventor: Douglas G. Willis, Colby, KS (US)

Correspondence Address: HOVEY WILLIAMS LLP, 2405 GRAND BLVD., SUITE 400, KANSAS CITY, MO, 64108, US

(21) Appl. No.: 11/277,579

(22) Filed: Mar. 27, 2006

(51) Int. Cl. B62D 51/04

(52) U.S. Cl. 180/19.1

(57) ABSTRACT

A detachable drive unit for shifting a mobile carriage is disclosed. The drive unit includes a frame with a carriage-coupling end and a handle end. The drive unit also includes drive wheels and transport wheels rotatably attached to the frame, a motor mounted on the frame, a gear train that drivingly interconnects the motor and drive wheels, and throttle and direction controls attached adjacent the handle end. The drive unit further includes a coupler that is pivotally attached to the frame adjacent the carriage-coupling end. The coupler releasably grasps the carriage and permits upward swinging of the handle end to disengage the drive wheels from the surface while the drive unit is attached to the carriage.

### BACKGROUND OF THE INVENTION

1. Field of the Invention

The present invention relates generally to trucks for moving wheeled load-supporting carts. More specifically, the present invention concerns a motorized drive unit that is removably attachable to a load-supporting carriage.

2. Discussion of Prior Art

Hand trucks and other manually-operated carts for moving loads are known in the art. Motorized trucks and carts for supporting and transporting loads are also known in the art.

Prior art motorized trucks are problematic and suffer from certain limitations. For example, prior art motorized trucks do not provide effective control over loads that are supported on carriages. In particular, these trucks do not permit a user to apply a selective force to a load through the use of variable wheel-slip. Prior art motorized trucks with releasably attachable couplers are also dangerous and cumbersome to use because the user must attach or detach the coupler from the load at a location adjacent to the load. Accordingly, there is a need for an improved motorized truck that does not suffer from these problems and limitations.

### SUMMARY OF THE INVENTION

A first aspect of the present invention concerns a detachable drive unit for facilitating movement of a wheeled carriage over a surface. The drive unit broadly includes a substantially rigid frame, a drive wheel, a motor, and a coupler. The substantially rigid frame includes a proximal carriage-coupling end and a distal handle end. The drive wheel is mounted on the frame and is operable to engage the surface and thereby drive the unit. The motor is mounted on the frame and is operable to power the drive wheel. The coupler is adjacent the carriage-coupling end and is operable to selectively couple the frame to the carriage so as to prevent relative translational movement therebetween. The coupler is configured to exert an upward force against the carriage when a downward force is applied on the handle end, with the drive wheel being spaced between the coupler and the handle end so that downward force on the handle end causes the drive wheel to be forced against the surface. The coupler is pivotally coupled to the frame about a pivot axis, wherein disengagement of the drive wheel from the surface is permitted by upward swinging of the handle end about the pivot axis while the frame remains coupled to the carriage.

A second aspect of the present invention concerns a detachable drive unit for facilitating movement of a mobile carriage over a surface, wherein the carriage is provided with a drive unit connector. The drive unit broadly includes a substantially rigid frame, a drive wheel, a motor, and a coupler. The substantially rigid frame includes a proximal carriage-coupling end and a distal handle end. The drive wheel is mounted on the frame and is operable to engage the surface and thereby drive the unit. The motor is mounted on the frame and is operable to power the drive wheel. The coupler is adjacent the carriage-coupling end and is operable to selectively couple the frame to the carriage so as to prevent relative translational movement therebetween. The coupler is configured to exert an upward force against the carriage when a downward force is applied on the handle end, with the drive wheel being spaced between the coupler and the handle end so that downward force on the handle end causes the drive wheel to be forced against the surface. The coupler includes a latch shiftable between a released position in which the frame is uncoupled from the carriage and a latched position in which the frame is coupled to the carriage. The coupler further includes a manually operable latch controller attached to the frame adjacent the handle end. The latch controller is configured to control shifting of the latch from the latched to the released position.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is a rearward perspective view of a detachable drive unit coupled to a carriage, with the detachable drive unit being constructed in accordance with a preferred embodiment of the present invention;

FIG. 2 is a forward perspective view of the detachable drive unit as shown in FIG. 1;

FIG. 3 is an exploded perspective view of a portion of the detachable drive unit shown in FIGS. 1-2, particularly illustrating the drive train of the drive unit;

FIG. 4 is a perspective view of the drive train of the detachable drive unit as shown in FIG. 3, but depicting the drive train in an assembled condition;

FIG. 5 is a partial cross-sectional view of the drive unit taken along line 5-5 in FIG. 4, showing the transmission in a disengaged position;

FIG. 6 is a partial cross-section view of the drive unit shown in FIG. 5, showing the transmission in an engaged position;

FIG. 7 is a rearward perspective view of the detachable drive unit shown in FIGS. 1-6, with parts being removed or sectioned to depict the direction control;

FIG. 8 is a fragmentary side view of the detachable drive unit shown in FIGS. 1-7, showing the direction control;

FIG. 9 is a cross-sectional view of the detachable drive unit taken along line 9-9 in FIG. 8, showing the direction control in a first position corresponding with a forward direction of the drive unit;

FIG. 10 is a cross-sectional view of the detachable drive unit similar to FIG. 9, but showing the direction control in a second position corresponding with a rearward direction of the drive unit;

FIG. 11 is a fragmentary, partially cross-sectioned, perspective view of the detachable drive unit as shown in FIGS. 1-10, with parts being removed or sectioned to depict the throttle control;

FIG. 12 is a fragmentary side view of the detachable drive unit as shown in FIGS. 1-11, showing the throttle control in a disengaged position;

FIG. 13 is a fragmentary side view of the detachable drive unit as shown in FIG. 12, showing the throttle control in an engaged position;

FIG. 14 is a fragmentary partially exploded perspective view of the detachable drive unit shown in FIGS. 1-13, showing the coupler and frame of the drive unit;

FIG. 15 is a lower fragmentary perspective view of the detachable drive unit and carriage shown in FIG. 1, showing the drive unit prior to attachment to the carriage;

FIG. 16 is a fragmentary side view of the detachable drive unit and carriage shown in FIGS. 1 and 15, again showing the drive unit prior to attachment to the carriage;

FIG. 17 is a fragmentary side view of the detachable drive unit and carriage shown in FIGS. 1, 15, and 16, showing the drive unit attached to the carriage;

FIG. 18 is a fragmentary bottom elevation view of the detachable drive unit and carriage shown in FIGS. 1 and 15-17, showing the drive unit prior to attachment to the carriage and the latch in the released position; and

FIG. 19 is a fragmentary bottom elevation view of the detachable drive unit and carriage shown in FIGS. 1 and 15-18, showing the drive unit attached to the carriage and the latch in the latched position.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE PREFERRED EMBODIMENTS

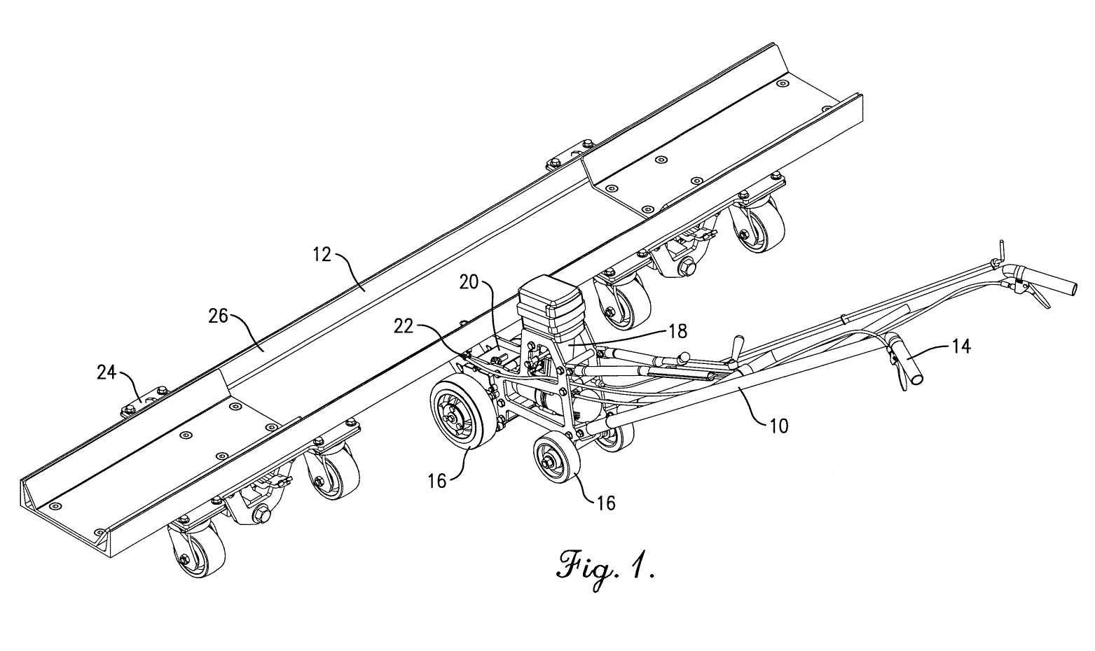

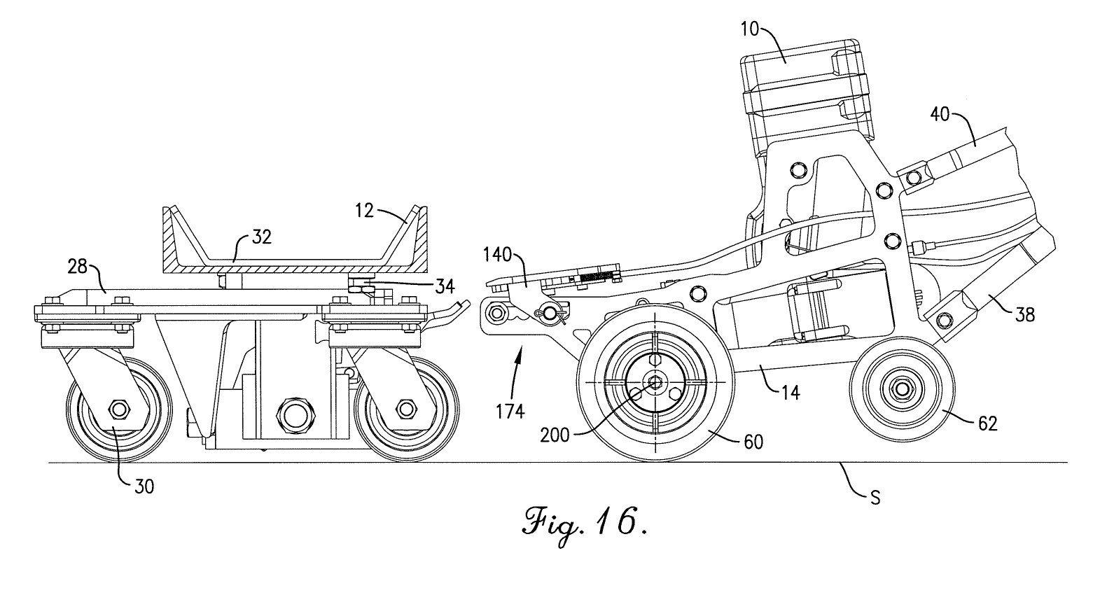

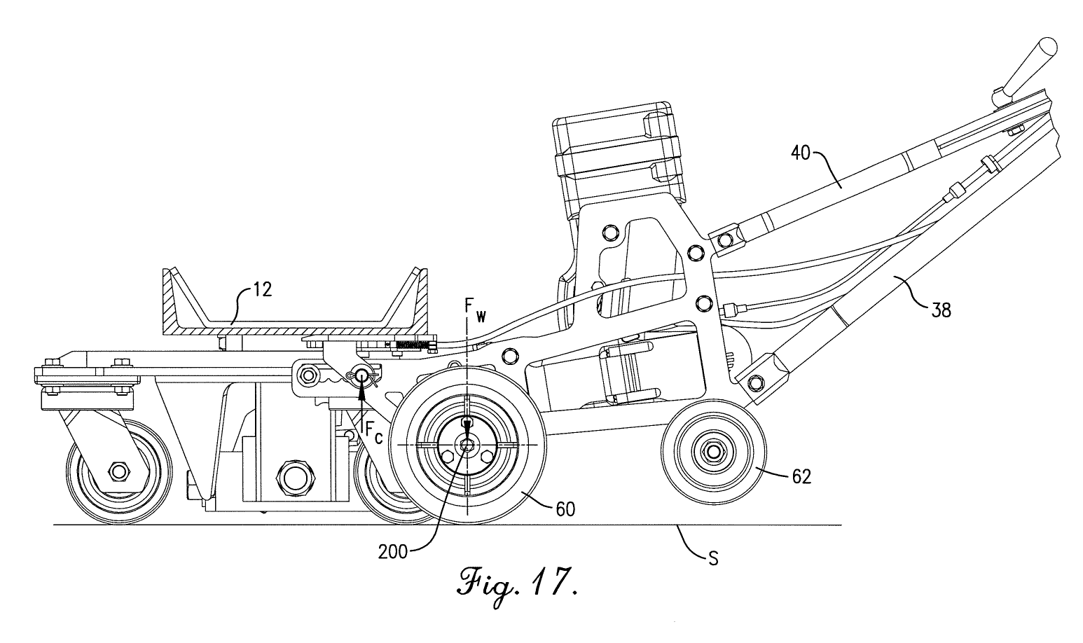

FIG. 1 illustrates a detachable drive unit 10 used in connection with a carriage 12 for transporting a load (not shown). The drive unit 10 is configured for selectively moving the illustrated carriage 12 over a surface S (see FIGS. 16 and 17). However, the principles of the present invention are equally applicable where the drive unit 10 is used to move other types of carts, trailers, or load-hauling vehicles. The drive unit 10 broadly includes a frame 14, wheels 16, a powered motor 18, drive train 20, and pivotal coupler 22.

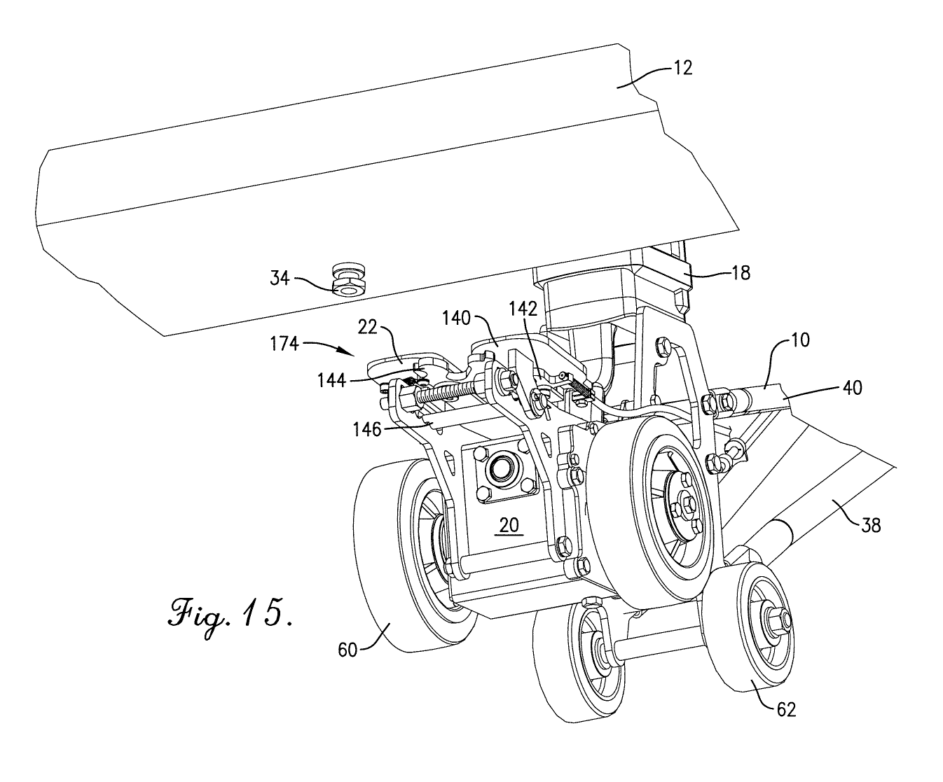

Turning to FIGS. 1 and 15-19, the carriage 12 includes caster assemblies 24 and a carriage frame 26. Each caster assembly 24 includes a base section 28 and three casters 30. The frame carriage 26 includes a load-supporting section 32 and a pin 34, the purpose of which will be discussed in greater detail. Additional details of similar caster assemblies are disclosed in co-pending U.S. patent application Ser. No. 10/886,369, filed Jul. 6, 2004, entitled ARTICULATED CASTER; co-pending U.S. patent application Ser. No. 11/164,578, filed Nov. 29, 2005, entitled ARTICULATED CASTER BRAKING SYSTEM; co-pending U.S. patent application Ser. No. 11/277,538, filed Mar. 27, 2006, entitled ARTICULATED CASTER; co-pending U.S. patent application Ser. No. 11/277,546, filed Mar. 27, 2006 entitled QUAD-CASTER CARRIAGE WITH FORKLIFT ATTACHMENT; and co-pending U.S. patent application Ser. No. 11/277,557, filed Mar. 27, 2006, entitled ARTICULATED CASTER WITH PIVOT BOX JOINT, all of which are hereby incorporated by reference herein.

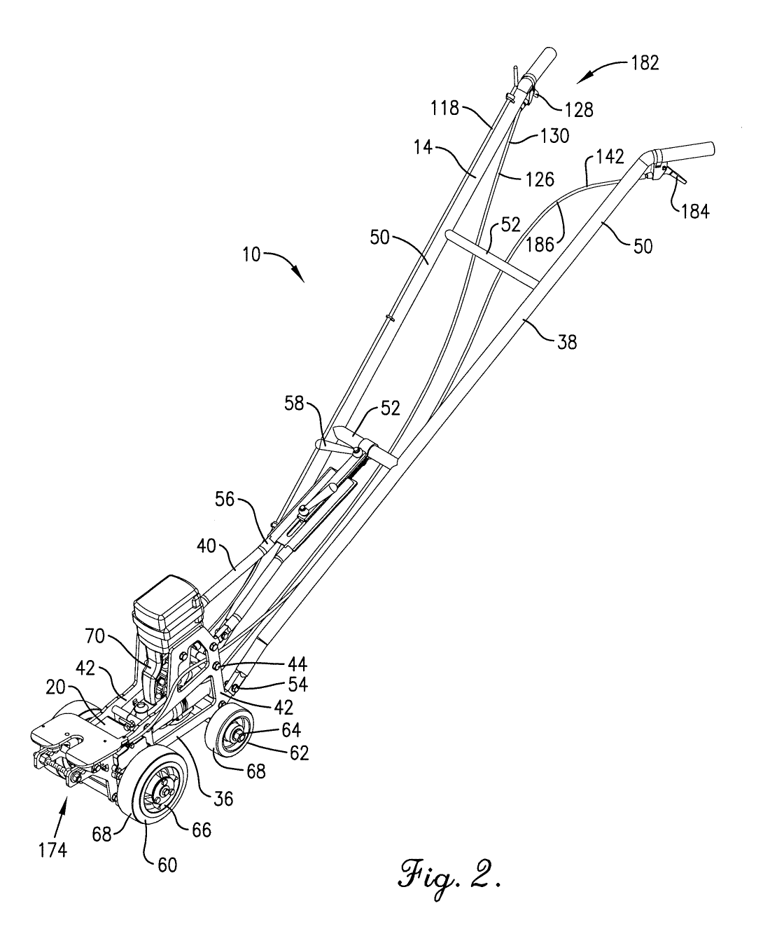

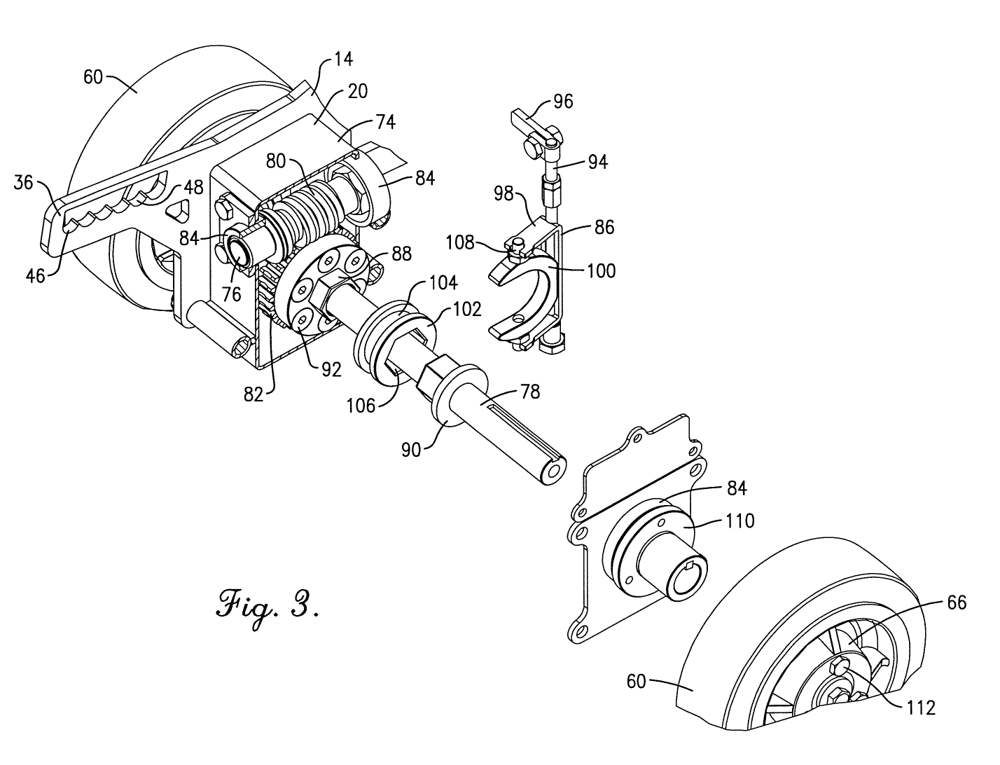

Turning to FIGS. 1 and 2, the frame 14 includes a body portion 36, a handle portion 38, and a handle adjustment portion 40. The body portion 36 includes plates 42 that are interconnected by fasteners 44 to create a substantially rigid structure. The plates 42 each include a slot 46 (see FIG. 3) that is partly defined by arcuate edge portions 48, the purpose of which will be described further. The handle portion 38 includes longitudinally extending handles 50 with tubular struts 52 that are welded to and thereby rigidly interconnect the handles 50. The handle portion 38 is pivotally attached to the body portion 36 by fasteners 54. Additionally, the body and handle portions 36,38 are further interconnected by handle adjustment portion 40. The handle adjustment portion 40 includes an adjustable length bar 56 that is pivotally attached to the portions 36,38, and fasteners 58 for fixing the bar 56 in a selected position. Thus, the handle adjustment portion 40 can be selectively lengthened to position the handle portion 38 relative to the body portion 36. The frame 14 is substantially rigid when the adjustment portion 40 is secured in the desired position. The illustrated body portion 36 is preferably constructed of carbon steel, while the handle and handle adjustment portions 38,40 are constructed of aluminum. However, the principles of the present invention are also applicable where the frame 14 is constructed from other metallic materials, or non-metallic materials, such as plastic.

The wheels 16 include drive wheels 60 and rear wheels 62. As will be further discussed, both drive wheels 60 are attached to the drive train 20 and are thereby powered by the motor 18, although the principles of the present invention are equally applicable to having only one of the drive wheels powered. The rear wheels 62 are rotatably attached to the frame 14 by fasteners 64. Those ordinarily skilled in the art will appreciate that the wheels 62 are provided so that the drive unit 10 is self-supporting when detached from the carriage 12 and thereby easily transportable. Furthermore, it is entirely within the ambit of the present invention to alternatively arrange or entirely remove the rear transport wheels 62. The wheels 18 each include a hub 66 and solid outer rim 68. The rim 68 preferably includes rubber or a similar elastomeric compound, which are particularly effective in providing the variable traction desired with the illustrated drive unit 10. However, it is within the ambit of the present invention that the rim 68 could also be made of a harder metallic or non-metallic material.

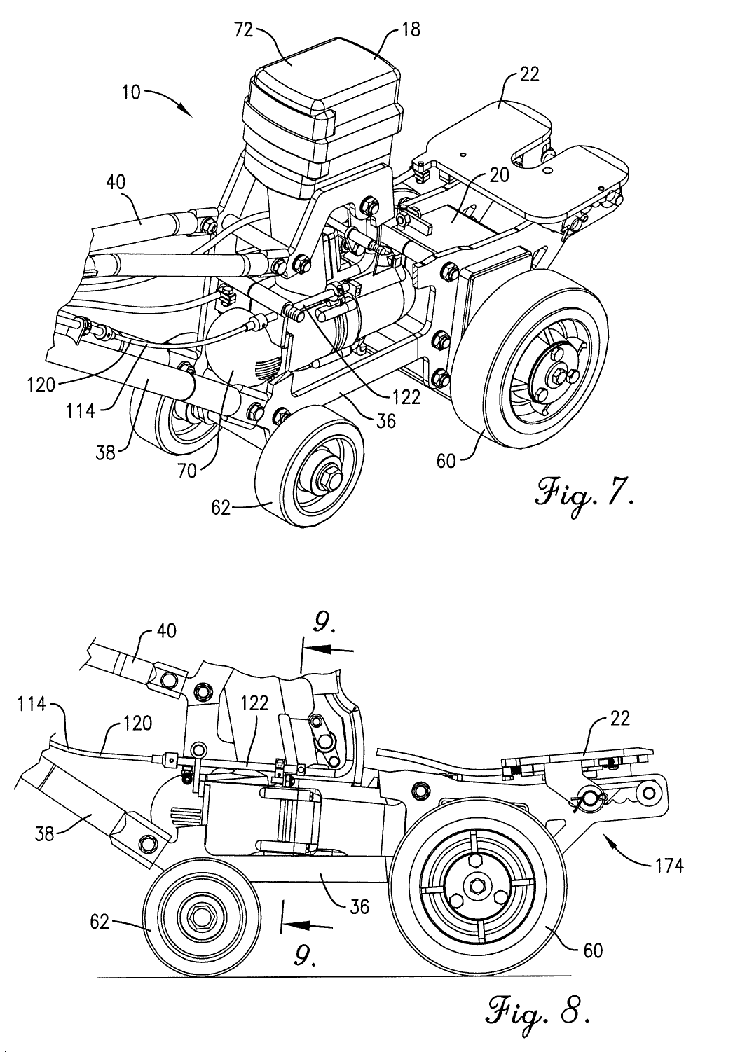

Turning to FIGS. 7 and 8, the powered motor 18 includes a case 70, an electric motor (not shown) housed within the case 70, and a battery 72. The electric motor is powered by direct-current, which is provided by the battery 72. The principles of the present invention are also applicable where the motor is powered by alternating-current or where the motor is pneumatically-driven or is an internal combustion motor. The principles of the present invention are further applicable where the motor 18 is powered by a source that is not mounted on the drive unit 10, e.g., by a corded connection to a stationary electrical source.

The battery 72 also includes a case that is releasably attachable to the case 70. The battery 72 preferably includes a rechargeable nickel-cadmium battery. However, it is within the ambit of the present invention for the battery 72 to include other types of rechargeable battery elements, such as lithium, nickel-metal-hydride, or lead acid.

The illustrated motor 18 is part of a cordless drill that has been adapted to provide motive power for the drive unit 10. However, the principles of the present invention are also applicable where the motor 18 and battery 72 are provided in other alternative constructions.

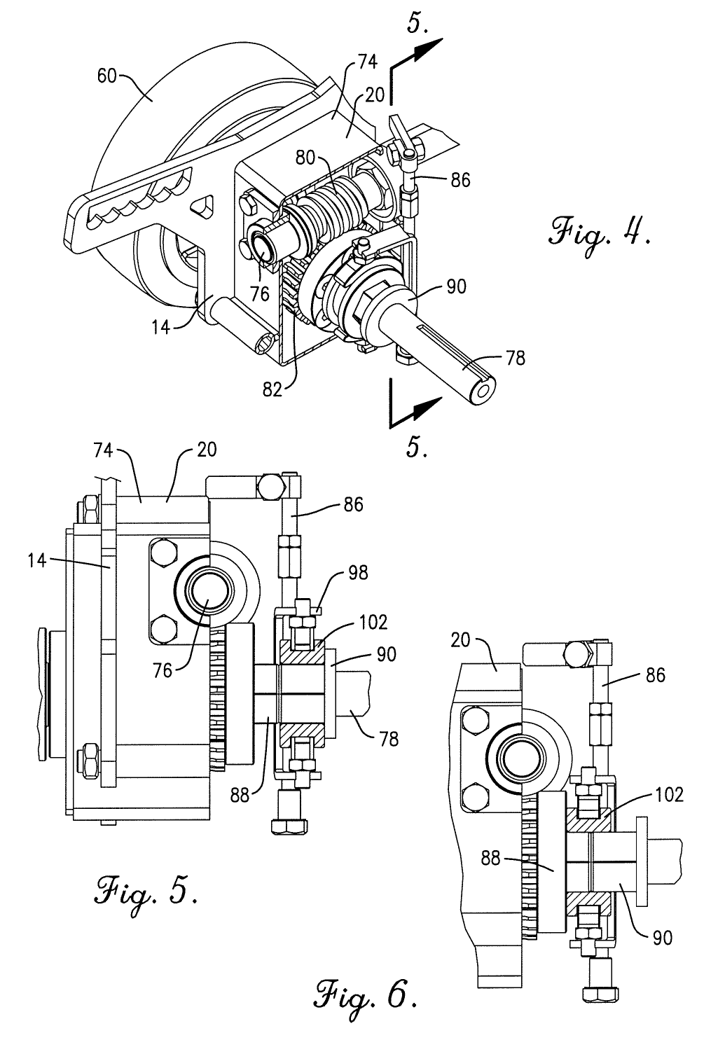

Turning to FIGS. 2-6, the drive train 20 includes a planetary gear train (not shown) within the case 70 that reduces the output speed of the motor 18. The drive train 20 further includes a case 74, input and output shafts 76,78 extending into the case 74, a worm gear 80 mounted on the input shaft 76, and a spur gear 82 mounted on the output shaft 78. The worm gear 80 is fixed to and thereby turns with the input shaft 76. The spur gear 82 is rotatable about the output shaft 78 and intermeshes with the worm gear 80. The gears 80,82 are secured relative to the case 74 with bushings 84.

The drive train 20 further includes a clutch 86 and inner and outer hex adapters 88,90. The inner adapter 88 is fixed to the spur gear 82 with fasteners 92 and the outer adapter 90 is fixed to the output shaft 78 in opposed relationship to the inner adapter 88. The clutch 86 is mounted to the case 74 and includes a pivot shaft 94, lever 96, clutch fork 98, bushing 100, and coupling 102. The coupling 102 includes a slotted outer circumference 104 and an internal hex profile 106 that mates with the adapters 88,90. The shaft 94 is rotatable relative to the case 74. The lever 96 and fork 98 are fixed to and thereby rotate with the shaft 94. The bushing 100 includes pins 108 that are received by the fork 98 and permit the bushing 100 to pivot relative to the fork 98 about an axis of the pins 108. The bushing 100 includes an opening to permit engagement with the coupling 102. In a disengaged position, the coupling 102 engages only the outer adapter 90 (see FIG. 5). In an engaged position, the coupling 102 engages both adapters 88,90 (see FIG. 6).

The drive train 20 is attached to the drive wheels 60 by fastening the hub 66 to a flange 110 of the output shaft 78 with fasteners 112. The input shaft 76 is attached to the planetary gear train. Thus, the drive train 20 interconnects the motor 18 and the drive wheels 60. With the clutch 86 in the disengaged position (see FIG. 5), the output shaft 78 is freely rotatable relative to the spur gear 82. In the engaged position (see FIG. 6), the output shaft 78 is fixed relative to the spur gear 82 and the motor 18 is operable to drive the drive wheels 60.

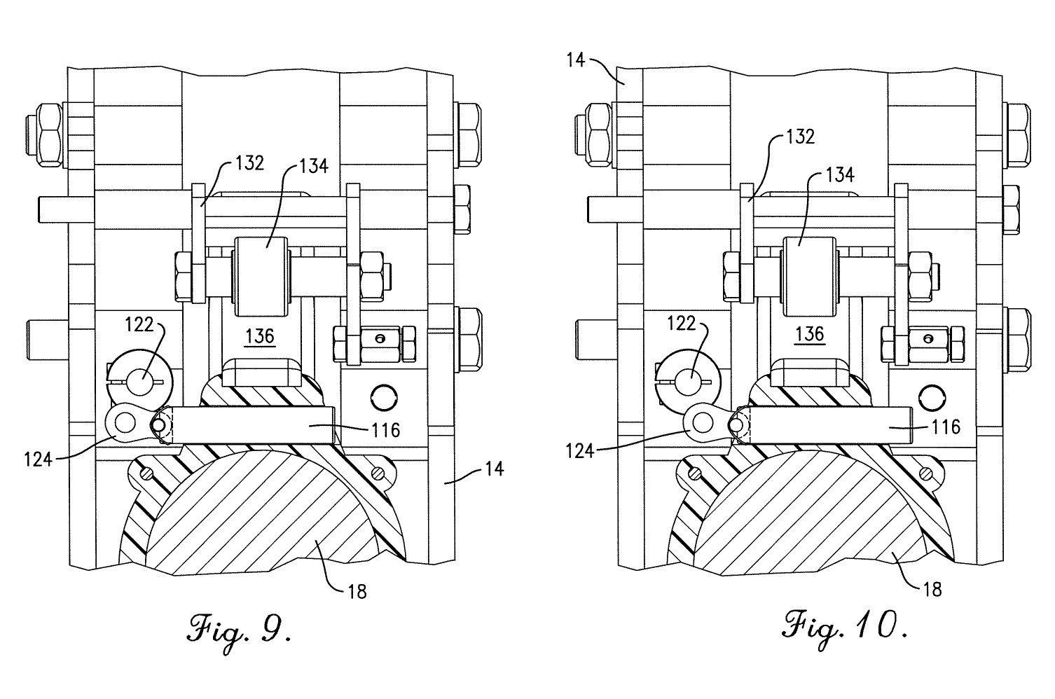

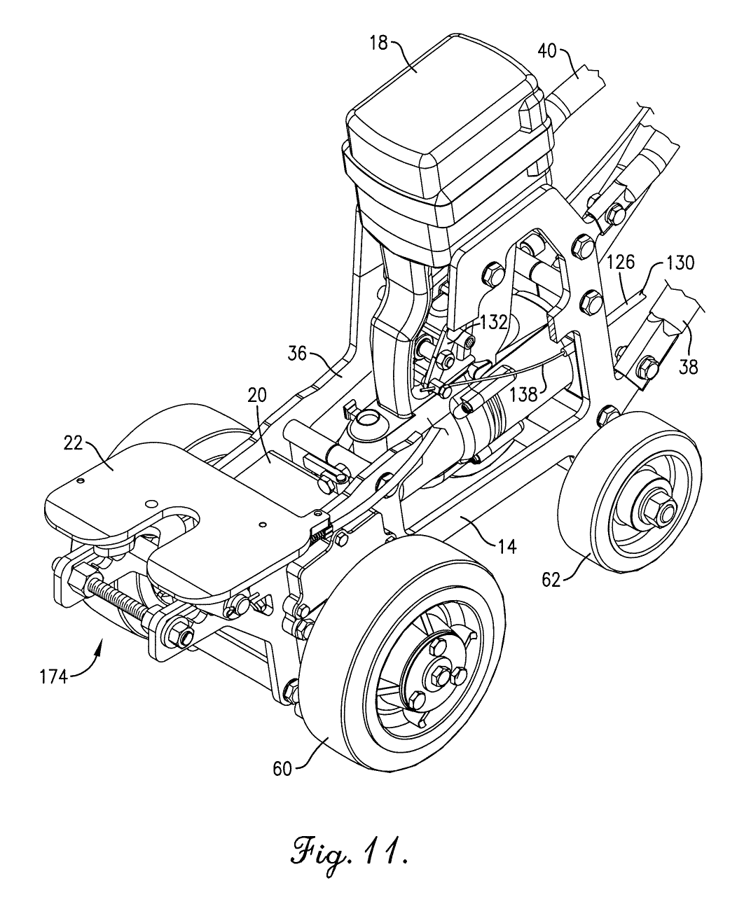

Turning to FIGS. 2 and 7-10, the drive train 20 further includes a direction control 114 including a toggle switch 116, control lever 118, control cable 120, lever 122, and arm 124. The toggle switch 116 is shiftable from side-to-side to engage the motor 18 in a forward direction (see FIG. 9), a reverse direction (see FIG. 10), and a neutral direction. The control lever 118 includes an elongated rod that is rotatably attached to the frame 14. Control cable 120 is attached to the control lever 118 and to lever 122. The arm 124 interconnects the lever 122 and the toggle switch 116 so that shifting of the toggle switch 116 is controllable by the control lever 118.

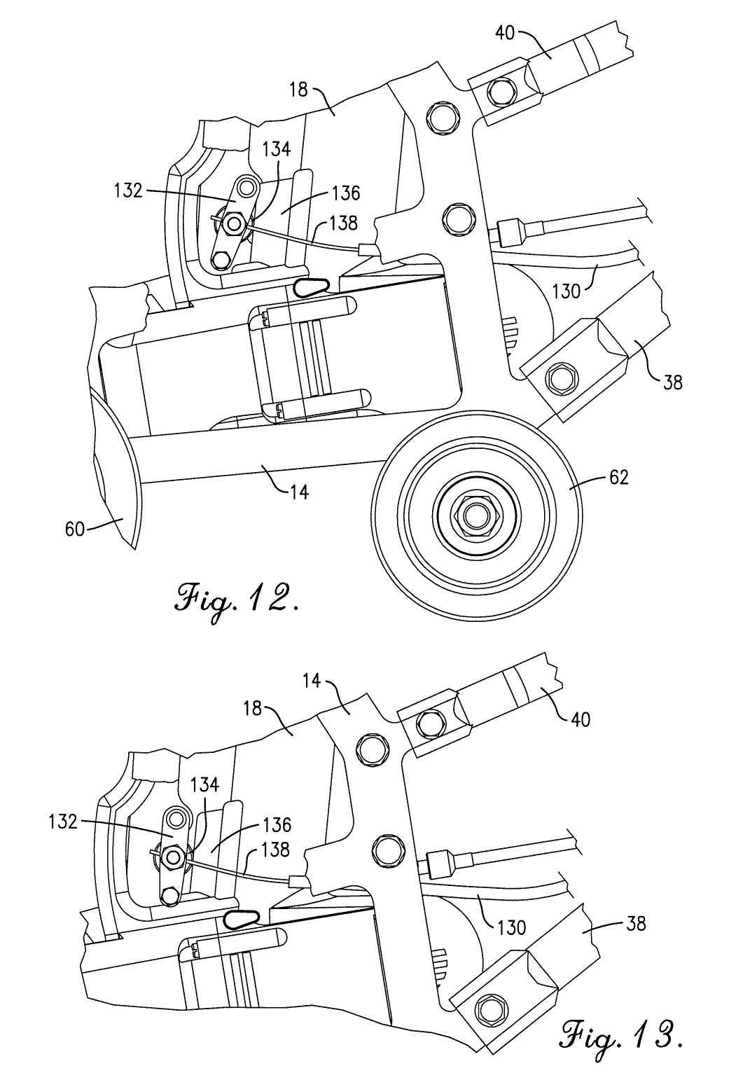

Turning to FIGS. 2 and 11-13, the drive train 20 also includes a throttle control 126 including a control lever 128, control cable 130, pivotal arm 132, roller 134, and switch 136. The control lever 128 and control cable 130 are attached to the frame 14. The control cable 130 is attached to the pivotal arm 132. The roller 134 is mounted on the arm 132 and contacts the switch 136. In the illustrated embodiment, the switch 136 constitutes the trigger of the drill, with the trigger serving to increase the amount of power to the motor 18 as the switch 136 is increasingly depressed. Shifting of the lever 128 causes an internal wire 138 of the cable 130 to move in a corresponding axial direction. In a first direction, engagement of the lever 128 shifts the switch 136 in a corresponding direction from an “OFF” position (see FIG. 12) to an “ON” position (see FIG. 13, where the switch 136 is depressed) to selectively apply power to the motor 18. Preferably, the throttle control 126 includes a spring (not shown) that biases the throttle control 126 back into the “OFF” position when the lever 128 is released. However, if desired, the return spring can be eliminated and the control can alternatively rely on the return of the trigger of the illustrated drill.

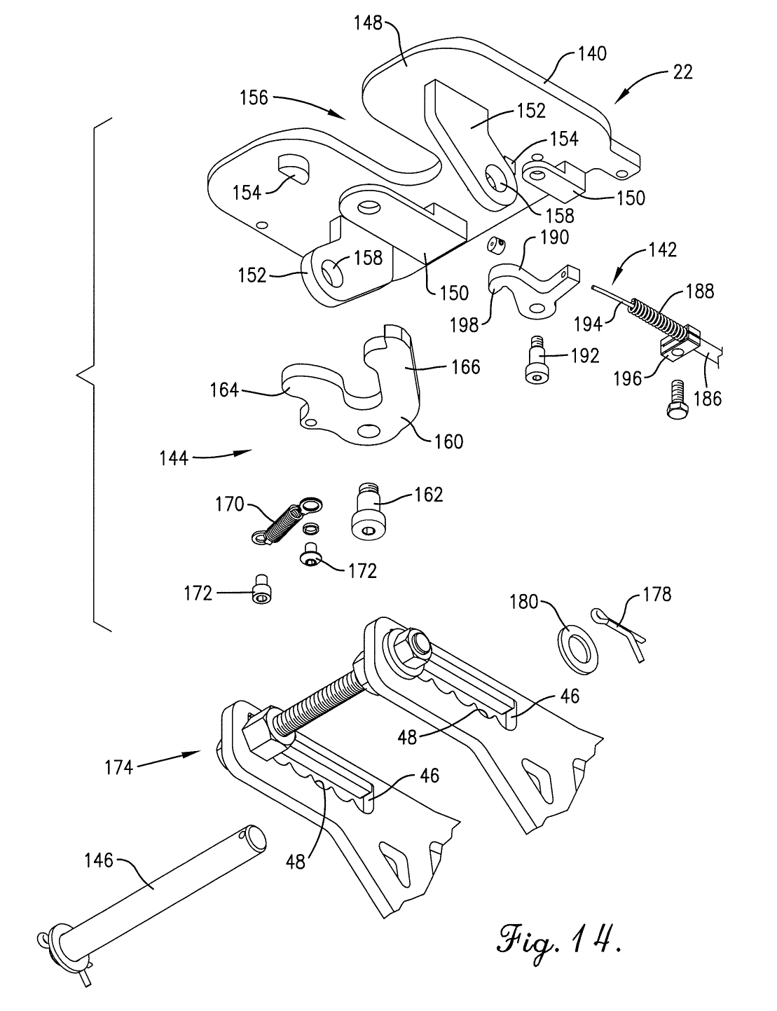

Turning to FIGS. 2 and 14-19, the coupler 22 includes a receiver 140, latch control 142, spring-loaded latch assembly 144, and pivot pin 146. The receiver 140 includes a plate 148, brackets 150, arms 152 for attaching receiver 140 to the frame 14, and stops 154. The plate 148 is U-shaped and presents a throat 156 operable to receive the pin 34 as will be discussed. The arms 140 have a common bore 158 running therethrough that cooperates with the frame 14 to provide a pivotal joint as will also be discussed.

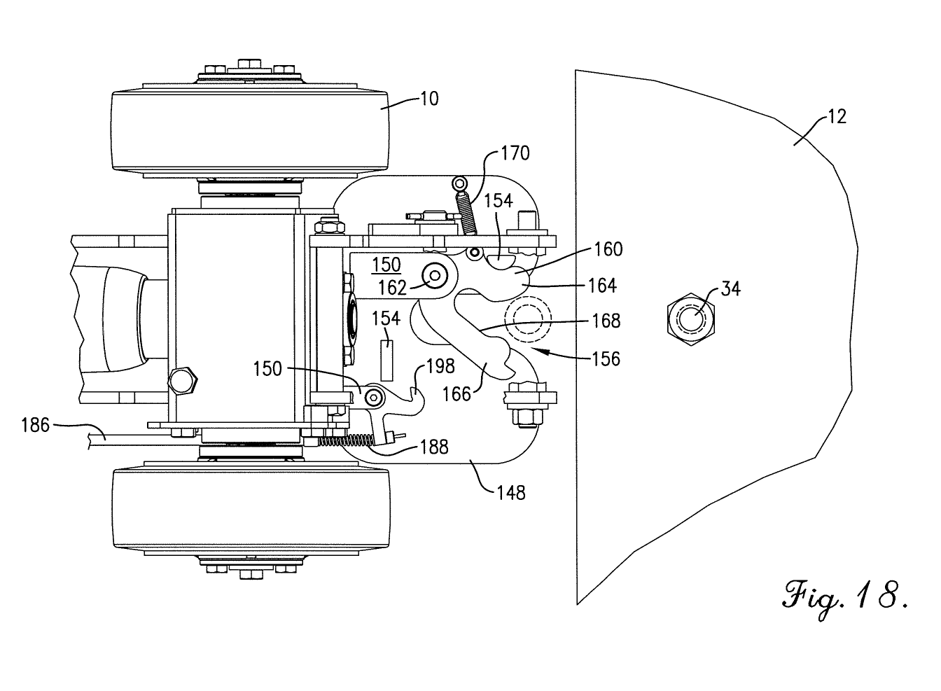

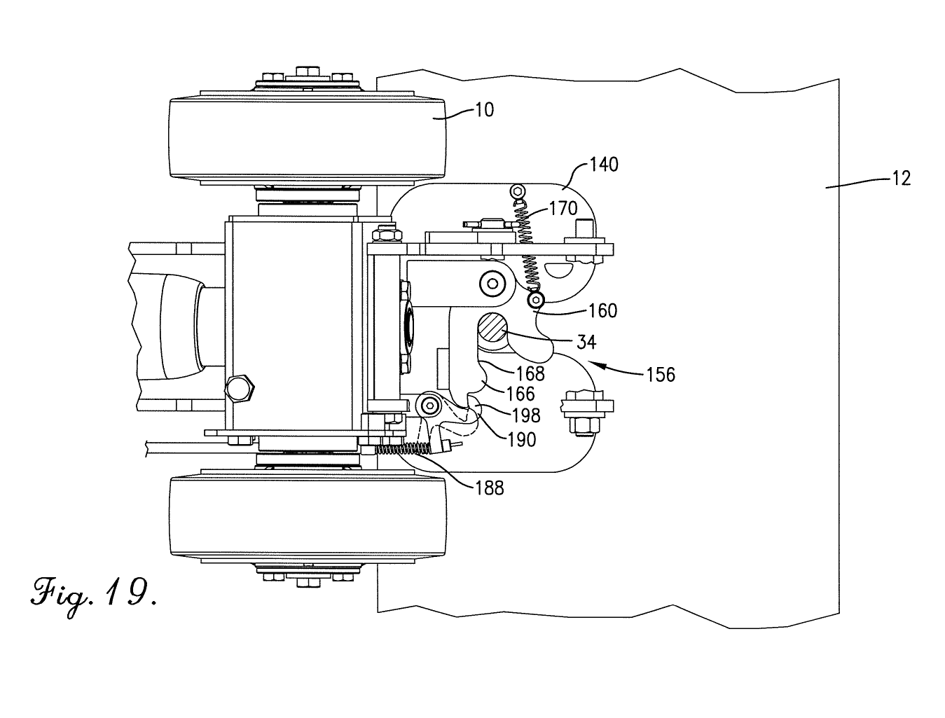

The latch assembly 144 includes a latch member 160 that is pivotally attached to the plate 148 by a screw 162. The latch member 160 is unitary and includes a latch arm 164 and a cam 166. The cam 166 presents a cam surface 168 operable to engage the pin 34 as the drive unit 10 and carriage 12 are moved toward one another. The latch assembly 144 also includes a spring 170 that is secured to the latch member 160 and plate 148 by screws 172. The latch member 160 is, therefore, pivotal relative to the plate 148 and is also biased into a released position by the spring 170 (see FIG. 18) where the latch arm 164 is substantially removed from the throat 156. The latch member 160 can also be shifted into a latched position (see FIG. 19) where the latch arm 164 extends across the throat 156.

The receiver 140 is pivotally attached to the frame 14 adjacent a carriage-coupling end 174 by pivot pin 176, cotter pins 178, and washers 180. The pivot pin 176 extends through bore 158 and through slots 46 as discussed above. The arcuate portions 48 of each slot 46 cooperatively define discrete locations that permit the coupler 22 to be located relative to the frame 14. The positionable coupler 22 permits the adjustment of mechanical advantage provided by the drive unit 10 for lifting the carriage 12. The positionable coupler 22 also permits the adjustment of the amount of pivotal throw required at a handle end 182 of the frame 14 in order to selectively engage and disengage the drive wheels 60.

The latch control 142 includes a control lever 184, a control cable 186, a spring 188, and a keeper 190. The lever 184, cable 186, and keeper 190 are attached to the frame 14. The keeper 190 is attached to the plate 148 with screw 192 and is pivotal about the screw 192. An inner wire 194 of the cable 186 is fixed to the keeper 190. Thus, the position of the keeper 190 is controllable by shifting the lever 184. The spring 188 is spaced between the keeper 190 and cable fastener 196 so that the keeper 190 is biased into the locked position (see FIG. 19). Shifting of the lever 184 causes the keeper 190 to retract from the locked position to an unlocked position (as referenced by dotted lines in FIG. 19).

As the latch member 160 is shifted into the latched position, the cam 166 displaces the keeper 190 from a locking position and compresses the spring 188. As the latch member 160 shifts beyond a notched end 198 of the keeper 190, the spring 188 biases the keeper 190 to return to the locking position, where the keeper 190 engages the cam 166 and thereby locks it into that position. Subsequent shifting of the lever 184 shifts the keeper 190 out of the locked position until the cam 166 is released and the latch member 160 is biased into the released position.

The latch member 160, in the open position, is operable to receive the pin 34. As the pin 34 enters the throat 156 (e.g., as the drive unit 10 and carriage 12 are moved toward one another), the pin 34 engages the cam surface 168 and forces the latch member 160 from the unlatched position to the latched position. As the latch member 160 is shifted into the latched position, the keeper 190 locks the latch member 160. As shown particularly in FIG. 19, the latch member 160 is locked and thereby cooperates with the receiver 140 to grasp the pin 34 within the throat 156 so that the drive unit 10 and carriage 12 are releasably interconnected. In particular, the latch arm 164 and cam 166 cooperatively restrict movement of the pin 34 along the throat 156. However, the principles of the present invention are applicable where the latch member 160 permits some movement of the pin 34 within the throat 156 while retaining the pin 34 therein. The illustrated latched engagement of the drive unit 10 and carriage 12 substantially restricts relative translational movement therebetween, but permits relative pivotal movement about an axis of the pin 34. Additionally, the relative pivotal movement between the coupler 22 and frame 14 permits the drive unit 10 to pivot about pivot pin 146 (as discussed above) relative to the carriage 12. Such pivotal movement is particularly useful when it is desired to disengage the drive wheels 60 from the surface S (corresponding to upward swinging of the handle end 182) while maintaining the illustrated pivotal connection between the carriage 12 and drive unit 10. Furthermore, such a pivotal connection permits the user to variably increase (or decrease) the traction of the drive wheels by swinging the handle end 182 downward (or upward). Most notably, the traction is varied without having to lift (or pivot) the carriage 12, which is often impossible when the carriage 12 is supporting large loads (e.g., loads in excess of one ton).

The keeper 190 is released from the locking position by depressing the lever 184 and thereby retracting the keeper 190 until it disengages the latch member 160. The disengaged latch member 160 is then biased into the open or release position (see FIG. 18) by the spring 170 and, in some circumstances, by force applied to the latch arm 164 by the pin 34 (i.e., where the drive unit 10 and carriage 12 are biased to move apart from each other). With the latch member 160 in the release position, the throat 156 is opened and the drive unit 10 and carriage 12 are permitted to move translationally relative to each other (e.g., move apart from each other).

Turning to FIGS. 16-19, the drive unit 10 is engaged with the carriage 12 by rotating the handle end 182 upwardly so that the frame 14 generally pivots about a drive wheel axis 200. In some circumstances, such pivoting may occur about a contact location between the drive wheels 60 and the surface S. Upward pivoting of the handle end 182, from the drive unit's self-supported orientation on the surface S, results in the transport wheels 62 being disengaged from the surface S (see FIG. 16). In this manner, the coupler 22 is pivoted in a downward direction for engagement with the pin 34 (see FIG. 17). When the drive unit 10 and carriage 12 are attached, the drive wheels 60 remain engaged with the surface S. The attached drive unit 10 remains pivotal about the drive wheel axis 200 with the frame 14 providing a lever that pivots about a fulcrum provided by the drive wheels 60. In other words, a downward force (not shown) applied to the handle end 182 operates to exert an upward force F_{c} on the carriage-coupling end 174 (see FIG. 17). The downward force causes a downward force F_{w} on the drive wheels 60 to increase proportionally. Similarly, an upward force (not shown) on the handle end 182 proportionally reduces the force F_{w} on the drive wheels 60 and the upward handle force can reach a level where the drive wheels 60 become disengaged with the surface S.

The attached drive unit 10 is operable to shift the carriage 12 when the powered motor 18 is activated and causes the drive wheels 60 to rotate. The force F_{w} on the drive wheels 60 partly determines whether the drive wheels 60 slip relative to surface S and to what extent the wheel slip occurs. This variable wheel slip is operable to reduce the amount of force that would otherwise be applied by the drive unit 10 to the carriage 12. In this manner, the wheel slip preferably permits the drive unit 10 to apply a variable force to the carriage 12. Furthermore, in some circumstances, it might be desirable to permit the carriage 12 to “coast” while maintaining connection between the drive unit 10 and carriage 12. This is accomplished simply by swinging the handle portion 38 of the frame 14 upwardly until the drive wheels 60 are disengaged from the surface.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A detachable drive unit for facilitating movement of a wheeled carriage over a surface, said drive unit comprising:
a substantially rigid frame including a proximal carriage-coupling end and a distal handle end;
a drive wheel mounted on the frame and operable to engage the surface and thereby drive the unit;
a motor mounted on the frame and operable to power the drive wheel; and
a coupler adjacent the carriage-coupling end and operable to selectively couple the frame to the carriage so as to prevent relative translational movement therebetween,
said coupler being configured to exert an upward force against the carriage when a downward force is applied on the handle end, with the drive wheel being spaced between the coupler and the handle end so that downward force on the handle end causes the drive wheel to be forced against the surface,
said coupler being pivotally coupled to the frame about a pivot axis, wherein disengagement of the drive wheel from the surface is permitted by upward swinging of the handle end about the pivot axis while the frame remains coupled to the carriage.

2. The detachable drive unit as claimed in claim 1,
said coupler including a pin that pivotally couples the coupler to the frame and thereby provides the pivot axis.

3. The detachable drive unit as claimed in claim 2,
said drive wheel presenting a drive wheel axis about which the wheel rotates,
said pin being spaced above the drive wheel axis.

4. The detachable drive unit as claimed in claim 3,
said drive wheel axis and said pivot axis being parallel.

5. The detachable drive unit as claimed in claim 3,
said pin being spaced above the surface.

6. The detachable drive unit as claimed in claim 2,
said frame presenting a plurality of discrete pin-receiving locations so that the position of the pivot axis is adjustable.

7. The detachable drive unit as claimed in claim 6,
said frame presenting a pair of slots adjacent the carriage-coupling end, with each one of the slots being configured to receive the pin therein,
said slots cooperatively presenting a plurality of aligned arcuate portions, with each of the aligned arcuate portions defining a corresponding one of the pin-receiving locations.

8. The detachable drive unit as claimed in claim 1,
a second drive wheel spaced from the first-mentioned drive wheel, with the drive wheels cooperatively presenting a common drive wheel axis.

9. The detachable drive unit as claimed in claim 8,
said drive wheels cooperatively providing a fulcrum about which the frame pivots when the drive wheels engage the surface and the downward force is applied against the handle end.

10. The detachable drive unit as claimed in claim 8; and
a transport wheel rotatably attached to the frame and spaced from the drive wheels to engage the surface and make the drive unit self-supporting when the drive unit is not attached to the carriage.

11. The detachable drive unit as claimed in claim 1,
said frame including a longitudinal axis extending between the carriage-coupling end and the handle end,
said pivot axis being perpendicular to the longitudinal axis.

12. The detachable drive unit as claimed in claim 1,
said coupler including a receiver plate presenting an open carriage-connector-receiving throat,
said coupler further including a releasable latch shiftably coupled to the receiver plate for shifting between a latched position in which the latch extends across throat and a released position in which the latch is at least substantially removed from the throat.

13. The detachable drive unit as claimed in claim 12,
said latch being pivotally attached to the receiver plate,
said coupler including a cam operably connected to the latch,
said cam presenting a cam surface which is configured to be engaged by the carriage to thereby shift the latch from the released position to the latched position.

14. The detachable drive unit as claimed in claim 13,
said coupler including a releasable keeper operable to lock the latch in the latched position,
said coupler including a latch controller attached to the frame adjacent the handle end,
said latch controller being configured to selectively release the keeper and thereby unlock the latch from the latched position.

15. The detachable drive unit as claimed in claim 14,
said latch being yieldably biased from the latched position to the released position.

16. A detachable drive unit for facilitating movement of a mobile carriage over a surface, wherein the carriage is provided with a drive unit connector, said drive unit comprising:
a substantially rigid frame including a proximal carriage-coupling end and a distal handle end;
a drive wheel mounted on the frame and operable to engage the surface and thereby drive the unit;
a motor mounted on the frame and operable to power the drive wheel; and
a coupler adjacent the carriage-coupling end and operable to selectively couple the frame to the carriage so as to prevent relative translational movement therebetween,
said coupler being configured to exert an upward force against the carriage when a downward force is applied on the handle end, with the drive wheel being spaced between the coupler and the handle end so that downward force on the handle end causes the drive wheel to be forced against the surface,
said coupler including a latch shiftable between a released position in which the frame is uncoupled from the carriage and a latched position in which the frame is coupled to the carriage,
said coupler further including a manually operable latch controller attached to the frame adjacent the handle end,
said latch controller being configured to control shifting of the latch from the latched to the released position.

17. The detachable drive unit as claimed in claim 16,
said coupler being pivotally coupled to the frame about a pivot axis, wherein disengagement of the drive wheel from the surface is permitted by upward swinging of the handle end about the pivot axis while the frame remains coupled to the carriage.

18. The detachable drive unit as claimed in claim 17,
said coupler including a pin that pivotally couples the coupler to the frame and thereby provides the pivot axis.

19. The detachable drive unit as claimed in claim 18,
said drive wheel presenting a drive wheel axis about which the wheel rotates,
said pin being spaced above the drive wheel axis.

20. The detachable drive unit as claimed in claim 19,
said drive wheel axis and said pivot axis being parallel.

21. The detachable drive unit as claimed in claim 19,
said pin being spaced above the surface.

22. The detachable drive unit as claimed in claim 18,
said frame presenting a plurality of discrete pin-receiving locations so that the position of the pivot axis is adjustable.

23. The detachable drive unit as claimed in claim 22,
said frame presenting a pair of slots adjacent the carriage-coupling end, with each one of the slots being configured to receive the pin therein,
said slots cooperatively presenting a plurality of aligned arcuate portions, with each of the aligned arcuate portions defining a corresponding one of the pin-receiving locations.

24. The detachable drive unit as claimed in claim 16,
a second drive wheel spaced from the first-mentioned drive wheel, with the drive wheels cooperatively presenting a common drive wheel axis.

25. The detachable drive unit as claimed in claim 24,
said drive wheels cooperatively providing a fulcrum about which the frame pivots when the drive wheels engage the surface and the downward force is applied against the handle end.

26. The detachable drive unit as claimed in claim 24; and
a transport wheel rotatably attached to the frame and spaced from the drive wheels to engage the surface and make the drive unit self-supporting when the drive unit is not attached to the carriage.

27. The detachable drive unit as claimed in claim 16,
said frame including a longitudinal axis extending between the carriage-coupling end and the handle end,
said pivot axis being perpendicular to the longitudinal axis.

28. The detachable drive unit as claimed in claim 16,
said coupler including a receiver plate presenting an open throat configured to receive the drive unit connector of the carriage,
said releasable latch being shiftably coupled to the receiver plate and cooperating therewith to grasp the connector within the throat when in the latched position and release the connector from the throat when in the released position.

29. The detachable drive unit as claimed in claim 28,
said latch extending across the throat when in the latched position and being removed from the throat when in the released position.

30. The detachable drive unit as claimed in claim 28,
said latch being pivotally attached to the receiver plate,
said coupler including a cam operably connected to the latch,
said cam presenting a cam surface which is configured to be engaged by the connector to thereby shift the latch from the released position to the latched position.

31. The detachable drive unit as claimed in claim 16,
said coupler including a releasable keeper operable to lock the latch in the latched position,
said latch controller being configured to selectively release the keeper and thereby unlock the latch from the latched position.

32. The detachable drive unit as claimed in claim 31,
said latch being yieldably biased from the latched position to the released position.
